(19) United States
(12) Patent Application Publication
(10) Pub. No.: US 2009/0215646 A1
(43) Pub. Date: Aug. 27, 2009

(54) SYSTEM AND METHOD OF ANALYTE DETECTION USING DIFFERENTIAL RECEPTORS

(75) Inventors: Eric V. Anslyn, Austin, TX (US); John T. McDevitt, Austin, TX (US); Jason B. Shear, Austin, TX (US); Dean P. Neikirk, Austin, TX (US); Aaron T. Wright, San Diego, CA (US); Zhenlin Zhong, Wuhan (CN)

Correspondence Address: FULBRIGHT & JAWORSKI L.L.P., 600 CONGRESS AVE., SUITE 2400, AUSTIN, TX, 78701, US

(73) Assignee: The Board of Regents of the University of Texas Sy

(21) Appl. No.: 11/994,353

(22) PCT Filed: Jun. 30, 2006
(86) PCT No.: PCT/US06/25696

§ 371 Date: Aug. 4, 2008

Related U.S. Application Data
(60) Provisional application No. 60/696,057, filed on Jul. 1, 2005.

(51) Int. Cl. C40B 30/10; C40B 60/12

(52) U.S. Cl. 506/12; 506/39

(57) ABSTRACT

Methods and systems for detecting the presence of analytes are described. A fluid or gas sample containing one or more analytes may pass through a particle-based sensor array. Detection and analysis techniques may be applied to determine the identity and quantity of the analytes.

This application claims priority to U.S. Provisional Application No. 60/696,057 filed on Jul. 1, 2005, which is hereby incorporated by reference.

The government may own rights in the present invention pursuant to grant number EB000549 from the National Institutes of Health.

### BACKGROUND OF THE INVENTION

1. Field of the Invention

The present invention relates to a method and device for the detection of analytes. More particularly, the invention relates to the development of a sensor array system with differential receptors.

2. Brief Description of the Related Art

The development of smart sensors capable of discriminating different analytes, toxins, and bacteria has become increasingly important for clinical, environmental, health and safety, remote sensing, military, food/beverage and chemical processing applications. Many sensors capable of high sensitivity and high selectivity detection have been fashioned for single analyte detection

Most sensors involve single analyte detection where highly selective receptors are used. However, it may be difficult to create receptors that are highly selective for certain analytes. Additionally, many analytes of interest to the civilian, environmental, and medical communities have no corresponding highly selective receptors. Thus, there is a need to develop a single system that can detect many different analytes.

### SUMMARY OF THE INVENTION

Systems and methods of analyte detection may include one or more particles in one or more cavities on a supporting member of a sensor array. The particles may include a polymeric resin bead coupled to a receptor. The receptor may include two or more attracting components. The attracting components may associate and/or attract analytes and/or visualization agents. The receptors may include boronic acid attracting components. The receptors may be synthetic and may not be highly selective towards a specific analyte. The particles may be configured to interact with more than one analyte causing a detectable signal. In some embodiments, a plurality of particles may be positioned in a plurality of cavities. The interaction of the plurality of particles with one or more analytes may create a pattern of one or more detectable signals. The analytes present or the types of analytes present may be identifiable from the pattern. A pattern may be compared to the pattern of a known analyte or a known type of analyte to assess the identity of the analyte.

In some embodiments, a particle with one or more attracting arms may be positioned in a cavity of a sensor array. A fluid including one or more analytes may pass over the particles. The attracting arms of the particles may attract and/or associate with one or more of the analytes in the fluid. A visualization agent may be passed over the particles. The visualization agents may differentially interact with some or all of the particles that have analytes associated with the particles. The interaction of the visualization agent with the particles may produce a detectable signal. A detector optically coupled to the particles may detect the signal.

In some embodiments, a particle with one or more attracting arms may be positioned in cavities of a sensor array. One or more visualization agents may be passed over the particles. At least one visualization agent may associate with a particle. A fluid containing one or more analytes may then be passed over the particles. The analytes may displace visualization agents from the particles producing one or more detectable signals. The detectable signals may produce a pattern associated with an analyte, type of analyte, or mixture of analytes.

The sensor array may be washed with visualization agents, acid, and/or buffer after a signal is detected and reused.

Any embodiment discussed with respect to one aspect of the invention applies to other aspects of the invention as well. Moreover, any embodiment discussed in the context of a sub-genus or species may be applied in the context of any other sub-genus or species discussed herein.

The embodiments in the Example section are understood to be embodiments of the invention that are applicable to all aspects of the invention.

The use of the term “or” in the claims is used to mean “and/or” unless explicitly indicated to refer to alternatives only or the alternatives are mutually exclusive, although the disclosure supports a definition that refers to only alternatives and “and/or.”

Throughout this application, the term “about” is used to indicate that a value includes the standard deviation of error for the device or method being employed to determine the value.

Following long-standing patent law, the words “a” and “an,” when used in conjunction with the word “comprising” in the claims or specification, denotes one or more, unless specifically noted.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF THE DRAWINGS

Features and advantages of the methods and apparatus of the present invention will be more fully appreciated by reference to the following detailed description of presently preferred but nonetheless illustrative embodiments in accordance with the present invention when taken in conjunction with the accompanying drawings in which:

FIG. 1 depicts an embodiment of a particle with a receptor with two or more attracting components;

FIG. 2 depicts an embodiment of a base structure of a receptor;

FIG. 3A-F depict embodiments of receptors;

FIG. 4A depicts various carboxylic acids and sugars;

FIG. 4B depicts various phenol analytes;

FIG. 5 depicts an embodiment of a sensor array with multiple isolated sections;

FIG. 6 depicts an embodiment of a sensor array with particles;

FIG. 7 depicts an embodiment of coupling a receptor to a bead.

FIG. 8 depicts embodiments of receptors associated with indicators;

FIG. 9 depicts embodiments of pH indicators;

FIG. 10 depicts an embodiment of using of Ca(II) and xylenol orange in the detection of analytes;

FIG. 11 depicts some components commonly found in wine;

FIG. 12 depicts a representation of the results of adding alizarin to a sensor array for tartrate;

FIG. 13 depicts a representation of the results adding tartrate to a sensor array;

FIG. 14 depicts a representation a calibration curve depicting the selectivity of receptors;

FIG. 15 depicts tartrate and malate;

FIG. 16 depicts an embodiment of a receptor;

FIG. 17 depicts a representation of the results of adding ATP to a receptor having the general structure depicted in FIG. 16;

FIG. 18 depicts a representation of the results of the data after being treated with principle coordinate analysis;

FIG. 19 depicts alternate embodiments of receptors for detecting analytes;

FIG. 20 depicts an embodiment of a library of receptors for the detection of proteins;

FIG. 21 depicts an illustration of the differences in indicator uptake from different resin-bound receptors;

FIG. 22 depicts a two dimensional PCA plot; and

FIG. 23 depicts a an expanded PCA plot using PC axes 1-3 of the PCA plot depicted in FIG. 22.

### DETAILED DESCRIPTION OF EMBODIMENTS

Herein we describe a system and method for the simultaneous analysis of a fluid or gas containing multiple analytes. The system may generate patterns that are diagnostic for both individual analytes and mixtures of the analytes. The system, in some embodiments, is made of a combination of chemically sensitive particles, formed in an ordered array, capable of simultaneously detecting many different kinds of analytes in a fluid or gas rapidly. An aspect of the system is that the array may be formed using a microfabrication process, thus allowing the system to be manufactured in an inexpensive manner.

Some analyte detection systems and methods of using the analyte detection systems can be found in the following U.S. Patents and Patent Applications, which are incorporated herein by reference: U.S. patent application Ser. No. 09/616,731 entitled “METHOD AND APPARATUS FOR THE DELIVERY OF SAMPLES TO A CHEMICAL SENSOR ARRAY” to McDevitt et al., filed Jul. 14, 2000; U.S. Publication No. 2002-0160363 entitled “MAGNETIC-BASED PLACEMENT AND RETENTION OF SENSOR ELEMENTS IN A SENSOR ARRAY” to McDevitt et al., published on Oct. 31, 2002; U.S. Publication No. 2002-0064422 entitled “METHOD AND SYSTEM FOR COLLECTING AND TRANSMITTING CHEMICAL INFORMATION” to McDevitt et al., published on Apr. 3, 2003; U.S. Publication No. 2004-0053322 entitled “SYSTEM AND METHOD FOR THE ANALYSIS OF BODILY FLUIDS” to McDevitt et al., published on Mar. 18, 2004; U.S. Pat. No. 6,908,770 entitled “FLUID BASED ANALYSIS OF MULTIPLE ANALYTES BY A SENSOR ARRAY” to McDevitt et al., issued on Jun. 21, 2005; U.S. Pat. No. 6,680,206 entitled “SENSOR ARRAYS FOR THE MEASUREMENT AND IDENTIFICATION OF MULTIPLE ANALYTES IN SOLUTIONS” to McDevitt et al., issued on Jan. 20, 2004; U.S. Pat. No. 6,602,702 entitled “DETECTION SYSTEM BASED ON AN ANALYTE REACTIVE PARTICLE” to McDevitt et al., issued on Aug. 5, 2003; U.S. Pat. No. 6,589,779 entitled “GENERAL SIGNALING PROTOCOLS FOR CHEMICAL RECEPTORS IN IMMOBILIZED MATRICES” to McDevitt et al., issued on Jul. 8, 2003; U.S. Pat. No. 6,649,403 entitled “METHOD OF PREPARING A SENSOR ARRAY” to McDevitt et al., issued on Nov. 18, 2003; U.S. Pat. No. 6,713,298 entitled “SYSTEM FOR TRANSFERRING FLUID SAMPLES THROUGH A SENSOR ARRAY” to McDevitt et al., issued on Mar. 30, 2004; U.S. Publication No. 2003-0186228 entitled “PORTABLE SENSOR ARRAY SYSTEM” to McDevitt et al., published on Oct. 2, 2003; U.S. Publication No. 2002-0197622 entitled “METHOD AND APPARATUS FOR THE CONFINEMENT OF MATERIALS IN A MICROMACHINED CHEMICAL SENSOR ARRAY” to McDevitt et al., published on Dec. 26, 2002; U.S. patent application Ser. No. 10/924,285 entitled “SYSTEM AND METHOD FOR THE ANALYSIS OF BODILY FLUIDS” to McDevitt et al., filed on Aug. 23, 2004; U.S. patent application Ser. No. 11/010,816 entitled “METHOD AND SYSTEM FOR THE ANALYSIS OF SALIVA USING A SENSOR ARRAY” to McDevitt et al., filed on Dec. 13, 2004; U.S. patent application Ser. No. 11/039,054 entitled “FLUID BASED ANALYSIS OF MULTIPLE ANALYTES BY A SENSOR ARRAY” to McDevitt et al., filed on Jan. 20, 2005; U.S. Publication No. 2004-0029259 entitled “METHOD AND SYSTEM FOR THE DETECTION OF CARDIAC RISK FACTORS” published on Feb. 12, 2004; International Patent Application No. PCT/US03/23131 entitled “CAPTURE AND DETECTION OF MICROBES BY MEMBRANE METHODS” filed Jul. 24, 2003; U.S. patent application Ser. No. 10/522,499 entitled “CAPTURE AND DETECTION OF MICROBES BY MEMBRANE METHODS” filed Jan. 24, 2005; U.S. patent application Ser. No. 10/470,646 entitled “CAPTURE AND DETECTION OF MICROBES BY MEMBRANE METHODS” filed Jan. 24, 2005; U.S. patent application Ser. No. 10/522,926 entitled “CAPTURE AND DETECTION OF MICROBES BY MEMBRANE METHODS” filed Jan. 24, 2005; International Patent Application No. PCT/US04/03751 entitled “MULTI-SHELL MICROSPHERES WITH INTEGRATED CHROMATIC AND DETECTION LAYERS FOR USE IN ARRAY SENSORS” filed Feb. 9, 2004; U.S. patent application Ser. No. 11/022,176 entitled “INTEGRATION OF FLUIDS AND REAGENTS INTO SELF-CONTAINED CARTRIDGES CONTAINING MICROCHIP SENSOR ELEMENTS” filed on Dec. 22, 2004; U.S. Pat. No. 11/020,443 entitled “INTEGRATION OF FLUIDS AND REAGENTS INTO SELF-CONTAINED CARTRIDGES CONTAINING SENSOR ELEMENTS AND REAGENT DELIVERY SYSTEMS” filed on Dec. 22, 2004; U.S. Pat. No. 11/020,442 entitled “INTEGRATION OF FLUIDS AND REAGENTS INTO SELF-CONTAINED CARTRIDGES CONTAINING PARTICLE-BASED SENSOR ELEMENTS AND MEMBRANE-BASED SENSOR ELEMENTS” filed on Dec. 22, 2004; U.S. Pat. No. 11/022,365 entitled “INTEGRATION OF FLUIDS AND REAGENTS INTO SELF-CONTAINED CARTRIDGES CONTAINING PARTICLE AND MEMBRANE SENSOR ELEMENTS” filed on Dec. 22, 2004; U.S. Pat. No. 11/021,123 entitled “PARTICLE ON MEMBRANE ASSAY SYSTEM” filed on Dec. 22, 2004; U.S. Pat. No. 11/022,219 entitled “MEMBRANE ASSAY SYSTEM INCLUDING PRELOADED PARTICLES” filed on Dec. 22, 2004; and U.S. Provisional Patent Application entitled “ANALYTE DETECTION SYSTEMS AND METHODS INCLUDING SELF-CONTAINED CARTRIDGES WITH DETECTION SYSTEMS AND FLUID DELIVERY SYSTEMS” filed on Jun. 24, 2005 to McDevitt et al.

In some embodiments, the system may include a light source, a sensor array, and a detector. The sensor array may include a supporting member, which is formed to hold a variety of particles. In one embodiment, light from the light source may pass onto the particles in the array. A detector optically coupled to the particles may detect the interaction of the particle and the analyte.

In some embodiments, a supporting member of an array may be made of any material capable of supporting the particles. A portion of the supporting member may allow passage of an appropriate wavelength of light, such as visible light and/or ultraviolet light. The supporting member may also be made of a material substantially impervious to the fluid or gas in which the analyte is present. A variety of materials may be used including plastics (e.g., photoresist materials, acrylic polymers, carbonate polymers, etc.), glass, silicon based materials (e.g., silicon, silicon dioxide, silicon nitride, etc.) and metals, including metal ions.

In some embodiments, the supporting member may include a plurality of cavities. A cavity may be formed so that a particle is substantially contained within the cavity. In another embodiment, a plurality of particles may be contained within a single cavity. A cavity may substantially inhibit displacement of a particle during use.

The particles may include a receptor molecule coupled to a polymeric bead. The receptors may be synthetic. While many natural receptors may be highly selective for a specific analyte, a synthetic receptor may associate and/or interact with more than one analyte. This interaction may take the form of a binding/association of the receptors with the analytes. The polymeric resin may be made from one or more polymers including, but not limited to, agarous, dextrose, acrylamide, control pore glass beads, polystyrene-polyethylene glycol resin, amino terminated polystyrene-polyethylene glycol resin, polystyrene-divinyl benzene resin, formylpolystyrene resin, trityl-polystyrene resin, acetyl polystyrene resin, chloroacetyl polystyrene resin, aminomethyl polystyrene-divinylbenzene resin, carboxypolystyrene resin, chloromethylated polystyrene-divinylbenzene resin, hydroxymethyl polystyrene-divinylbenzene resin, 2-chliorotrityl chloride polystyrene resin, 4-benzyloxy-2′4′-dimethoxybenzhydrol resin (Rink Acid resin), triphenyl methanol polystyrene resin, diphenylmethanol resin, benzhydrol resin, succinimidyl carbonate resin, p-nitrophenyl carbonate resin, imidazole carbonate resin, polyacrylamide resin, 4-sulfamylbenzoyl-4′-methylbenzhydrylamine-resin (Safety-catch resin), 2-amino-2-(2′-nitrophenyl) propionic acid-aminomethyl resin (ANP Resin), p-benzyloxybenzyl alcohol-divinylbenzene resin (Wang resin), p-methylbenzhydrylarnine-divinylbenzene resin (MBHA resin), Fmoc-2,4-dimethoxy-4′-(carboxymethyloxy)-benzhydrylamine linked to resin (Knorr resin), 4-(2′,4′-Dimethoxyphenyl-Fmoc-aminomethyl)-phenoxy resin (Rink resin), 4-iydroxymethyl-benzoyl-4′-methylbenzhydrylamine resin (HMBA-MBHA Resin), p-nitrobenzophenone oxime resin (Kaiser oxime resin), and amino-2,4-dimethoxy-4′-(carboxymethyloxy)-benzhydrylamine handle linked to 2-chlorotrityl resin (Knorr-2-chlorotrityl resin). In one embodiment, the material used to form the polymeric resin is compatible with the solvent in which the analyte is dissolved. For example, polystyrene-divinyl benzene resin will swell within non-polar solvents, but does not significantly swell within polar solvents. Thus, polystyrene-divinyl benzene resin may be used for the analysis of analytes within non-polar solvents. Alternatively, polystyrene-polyethylene glycol resin will swell with polar solvents such as water. Polystyrene-polyethylene glycol resin may be useful for the analysis of aqueous fluids.

In some embodiments, amine terminated, polystyrene/polyethylene glycol resin beads may be used because they are highly water permeable and/or because they may give quick response times to penetration by analytes. The microenvironment within the interior of the beads may be similar to isopropanol. Hence, binding interactions that partially rely on electrostatic attractions may be enhanced within the beads relative to water. Some particles may have an extremely high avidity effect. The concentration of receptor within the interior of the beads may be on the order of molar, and hence once an analyte has found its way into the beads, it may be difficult for the analyte to diffuse out due to high concentrations of the receptors during its departure.

In some embodiments, a particle may include a receptor. A receptor may associate with one or more analytes and/or visualization agents. A receptor may include two or more attracting components, as depicted in FIG. 1. The attracting components may be functionally similar or different. The attracting components of the receptor may be the same functional group. For example, the attracting arms may comprise boronic acids. The attracting components may associate with one or more analytes and/or visualization agents. Attracting components may have a stronger association with an analyte or type of analyte when compared to other analytes or types of analytes. A first analyte may displace a second analyte from attracting components of a receptor when the association between the first analyte and the attracting components is stronger than the association between the second analyte and the attracting components. In an embodiment, a first type of analyte may displace a second type of analyte from attracting components of a receptor when the association between the first type of analyte and the attracting components is stronger than the association between the second type of analyte and the attracting components.

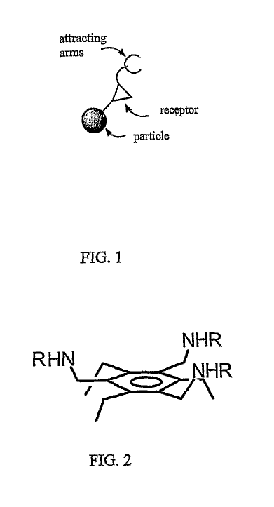

Attracting components of a receptor may be coupled to the polymeric bead by a linking component. FIG. 2 depicts an embodiment of a receptor. As depicted in FIG. 2, a receptor may include a base structure of 1,3,5-triaminomethyl-2,4,6-triethylbenzene. The base structure may have approximately a 5,000 to 1 preference for alternation of adjacent groups, although the barrier to conformational interconversion is only around 12 kcal/mol. This “steric gearing” may routinely impart about a 4 fold increase in binding compared to control structures missing the ethyl groups, and may lead to significantly higher yields in cyclization reactions. In an embodiment, isomers of these compounds may not need to be separated since they are interconverting rapidly at ambient temperature.

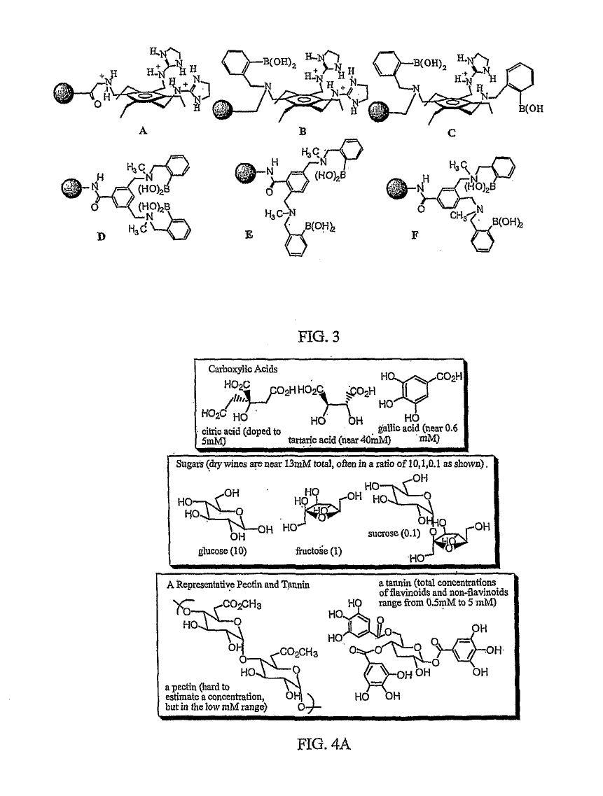

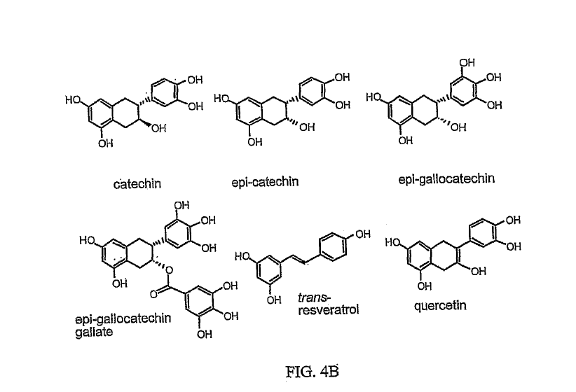

The attracting components of the receptor may comprise boronic acids. FIG. 3B-F depicts some embodiments of receptors coupled to polymeric beads that include boronic acid attracting components. The attracting component may comprise a boronic acid on an end of the attracting component. As used herein, “on an end” is understood as on a terminus of one or more of the arms of the attracting component; farther, as there may be one or more arms, there may be more than one end or terminus. Receptors similar to the receptors in FIG. 3A-B may associate with carboxylate compounds and/or natural products containing carboxylate compounds such as citrate and tartrate, see FIG. 4A. FIG. 3A depicts an embodiment of a synthetic receptor coupled with a signaling element for the analysis of a specific molecule that is part of a complex mixture of components. For example, the receptor depicted in FIG. 3A may associate with citrate in water over dicarboxylates, monocarboxylates, phosphates, sugars, and simple salts. Citrate is often used to spike white wine to give it a fruity flavor. The current analytical assays for citrate are HPLC based, and the FDA approved method is gravimetric; both being significantly more complex than our spectrophotometric analysis. Similarly, tartrate is monitored by HPLC in the wine making process. Due to its significant taste influencing properties, the ability to quickly, accurately, and cheaply monitor tartrate, along with other carboxylate natural products, would be a valuable tool in the quality control process in wineries.

Receptors similar to the receptor depicted in FIG. 3C may associate with tannic acids such as gallic acid, see FIG. 4A. Differences between epi-catechin, epi-gallocatechin, and epigallocatechin gallate may be distinguishable using combinatorial libraries. The only difference between catechin and epi-catechin is in one stereocenter, see FIG. 4B. It may be possible to distinguish between the compounds using differential receptors. Taunins often vary from one varietal of wine to another. These compounds are polyfused aromatic catechols and resorcinols -which are considered to be detrimental to the taste of red wines, but at low levels they contribute to the “full” flavor of reds. Tannins are postulated to impart the beneficial health effects of wine.

In some embodiments, a receptor may include bi-boronic acid attracting components. With respect to sugar recognition, it is well known that wines have four sugars present: fructose, sucrose, glucose, and even cellubiose. For example, sucrose and fructose are monitored in most all beverage manufacturing processes due to their significant taste influencing properties; however, there are no simple assays for these compounds. Receptors with bis-boronic acid attractive components may be used to detect the presence of sugars. FIG. 3D-F depict embodiments of receptors that may be used to detect the presence of sugars.

Receptors may include combinations of guanidiniums and boronic acids. The receptors may include various spatial arrangements of boronic acids. In some embodiments, the receptors may include amino acids that associate with tannic acids, pectins, and/or natural metabolites. The receptors may associate with one or more types of analytes including, but not limited to, carboxylates, sugars, pectins, tannins, glucoronides, hydroxylated heterocycles, and polycyclic aromatics. In some embodiments, the receptors may be selected to associate with pectins and/or tannins. Pectins are “globulous oligosaccharides” which impart a sweet taste to wine and contribute to the body of a wine. The degree of branching and molecular weight are thought to vary from one varietal to another.

The receptors may be coupled to a particle using carboxylic acids and/or amines in the receptor. In some embodiments, the receptors may be coupled to the particle such that the receptors exhibit similar selectivities, or similar abilities to associate, and/or similar color modulation as the receptors would in solution. It may be desirable for a particle with a receptor to retain a similar association strength to a receptor in solution.

In some embodiments, it may be desirable to use synthetic receptors. For sensing purposes, due to their simplicity, synthetic receptors often suffer interference from similar analytes. The use of synthetic receptors cannot compete with antibodies and aptamers for specificity of binding medium and large complex analytes. However, an array of synthetic receptors, when coupled with pattern recognition protocols, may form multi-analyte arrays capable of detecting complex analytes from complex solutions.

The inherent lack of specificity possessed by synthetic receptors may make using the synthetic receptors desirable. Synthetic receptors may be naturally cross-reactive and so when used in sensor arrays may associate with more than one analyte, which can be desirable. This type of “differential binding” can be desirable, since it can be desirable to use receptors that may interact with multiple analytes in the sensor array, and in many cases interact with unknown analytes, or analytes whose structures are not fully characterized. This is an attribute that may not be achieved with antibodies, aptamers, or other highly selective receptors.

Use of synthetic receptors may allow analysis of solutions for which the components are not exactly known. Furthermore, the use of synthetic combinatorial chemistry in the creation of unnatural receptors may compliment the differential binding and the cross reactivity desired in receptors for the sensor array. For example, where a solution contains compounds whose structures are not even known, as with pectins and many tannins, a combinatorial approach may be the only feasible option for identification and/or quantification of the compounds.

A sensor array may include a plurality of particles that include a plurality of receptors that all interact differently. Each receptor may also have different cross-reactive properties. Each section of the array may include different receptors and/or different indicators. In an embodiment, each receptor may bind a number of analytes, but each receptor may bind the analytes differently than every other receptor. A pattern of all the responses may be detected. The detectable pattern may be used to identify analytes present.

The most complete fingerprint of a solution may involve a direct quantitation of every single analyte in the solution. hi some instances, where only a handful of analytes are present within a class of structures, the detectable patterns produced by the receptors may be able to do this and produce a “quantitative-fingerprint”. However, with complex mixtures such as wine, where many of the tannins and pectins are not even known, or urine this is impossible or impractical. Therefore, the detectable patterns for complex mixtures may be used to differentiate solutions where subtly different mixtures of very structurally similar compounds are present and produce a “qualitative-fingerprint”. For example, detectable patterns produced by receptors after passing red wines though the sensor array may distinguish subtleties in concentrations and differing structures in various carboxylates, sugars, pectins, and tannins.

“Differential” receptors or sensors as used herein refer to receptors or sensors that have different interactions with the same analyte. Simply stated—the individual receptors all interact differently. Of course, this is true of an array of antibodies, in that each is highly specific. Protein and gene chips use differential receptors in this manner. However, differential also includes receptors that are cross-reactive. Each receptor may bind a number of analytes, but each receptor binds the analytes differently than every other receptor. In this case, a pattern of all the responses interpreted by a pattern recognition protocol gives the outcome/fingerprint. In this manner a plurality of receptors can be useful over a single receptor.

Using differential receptors to form an array may replace the common “lock and key” principle used in many analyte detection schemes with an array of differential sensors, where the receptors respond to many different analytes or classes of analytes (such as the classes of: carboxylates, sugars, and pectins/tannins). This may be a major strength of using differential receptors, since they may have the ability to discriminate between structurally similar individual analytes and similar mixtures of analytes.

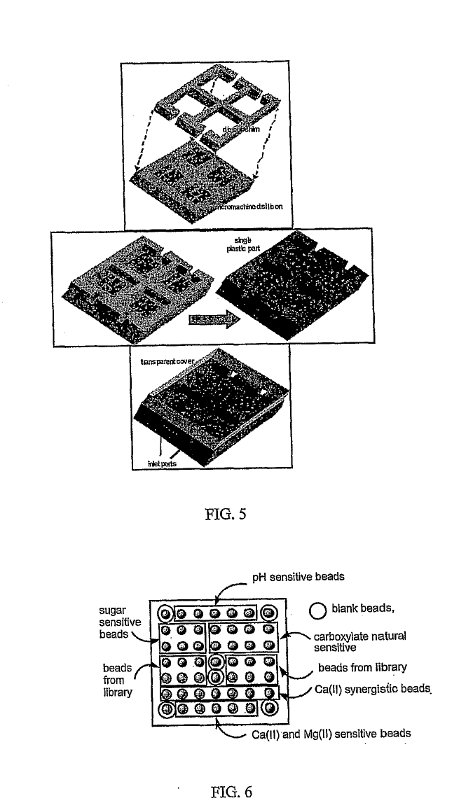

In some embodiments, a sensor array may include multiple isolated sections. Using multiple sections may facilitate pattern detection and analyte identification. FIG. 5 depicts an embodiment of an array with multiple isolated sections. FIG. 6 depicts an embodiment of a sensor array. Each of these various regions of the array can be analyzed separately. An array similar to the sensor array depicted in FIG. 5 may be used to analyze various mixtures of analytes (e.g., the analytes in wine). Creating an array with several different types of receptors allows the detector to process one or more signals for detection of, for example, red, green, and/or blue data streams from each bead, giving a very high degree of differential responses, and increasing the likelihood that various analytes or types of analytes may be differentiated.

In some embodiments, a system for detecting analytes may be used with different cartridges to detect a plurality of analytes. The system may include a housing that contains the optical platform. The housing may include a cartridge positioning system that positions a cartridge. The cartridge positioning system may automatically position the cartridge so that it is optically coupled to one or more light sources and/or one or more detectors. A computer or analyzer may be coupled to the housing to analyze the images and/or control the system. The system may include a display to show images captured by the detector and/or what analytes were detected. The system may include a temperature controller since ambient temperatures may vary depending on the location where the system is used. In some embodiments, system specifications may be automatically or manually adjusted depending on the type of analyte to be detected. The optical platform may include more than one detector and/or light sources. A detector may detect a signal from an analyte. A detector may detect absorption of one or more wavelengths of light by the analyte, the material retained on a membrane, a fluorophore, and/or a particle. A detector may detect the fluorescence of the analyte, the material retained on a membrane, a fluorophore, and/or a particle. A detector may be a CCD detector, a CMOS detector, a camera, a microscope, and/or a digital detector. For example, two light sources may be included in the optical platform and different combinations of light sources may be used to detect different analytes. In some embodiments, a detector may include several different lenses for the detection of different analytes. More than one lens may be used in the detection of some analytes. In an embodiment, different assays may require different exposure times when images of the detection systems are obtained. In an embodiment, fiber optic cables may be coupled to a detection system to facilitate image capturing.

In some embodiments, the array may be reusable. After detecting the pattern produced by the particles, the array may be washed with an acidic solution. After detecting the pattern produced by the particles, the array may be washed with a buffer and/or an anionic or cationic indicator. After the array is washed, it may be used for detection of analytes in another fluid or gas. For example, the array may be washed with anionic indicator, then the anionic analyte, then indicator, then analyte, etc.

In some embodiments, one or more visualization agents, such as indicators, may be added to the particles in the sensor array. Anionic indicators may be used with cationic receptors, so that binding will occur. Boronic acid containing receptors may be used with indicators that have vicinal diols, so that they will bind to the receptors.

One or more of the visualization agents may associate with the receptors on the particles. A fluid or gas containing one or more analytes may then be added to the particles. For example, a sample may pass over a surface of the supporting member of a sensor array and into or through cavities containing particles. The analytes may displace some of the visualization agents associated with the receptors on the particles. In an embodiment, the pH of the fluid containing analytes may be adjusted prior to adding the fluid to the particles. Addition of the untagged analyte (i.e. the material to be tested) results in a release of the tagged analytes (i.e. the visualization agent that is displaced upon binding of the material to be tested) and a spectroscopic modulation may be monitored. Analytes that have a stronger association with the receptor than the receptor has with the visualization agent may displace visualization agents. Since an array may include more than one type of receptor, some analytes may displace visualization agents from certain receptors but not from other receptors. In an embodiment, some types of analytes may displace the visualization agents from certain receptors only after a period of time. The displacement of visualization agents from one or more particles may create a detectable pattern. An image may be obtained of the pattern using one or more light sources and a detector optically coupled to the array. The pattern may be used to identify analytes present in the fluid or gas. The pattern may be compared to a pattern for a known analyte to determine if the analyte is present in the fluid or gas. Statistically based methods, pattern recognition algorithms, and neural,networks may be used to identify detectable patterns for analytes and/or types of analytes. A library of detectable patterns may be created to facilitate identification of analytes and/or types of analytes.

The detection of analytes using the sensor array is based on competitions between attractive forces between particles, analytes, and indicators. As depicted in FIG. 8A the assays may be based on displacement, where the indicator binds to the receptors, which may be designed or arise from library screening, by using, for example, hydrogen bonding, hydrophobic interactions, ion pairing, and/or boronate ester formation. Binding of the analyte may cause displacement of the indicator into the microenvironment of the bead, giving rise to a change in protonation state of the indicator. Hence, pH indicators may be most sensitive to this kind of an assay, giving rise to color changes and kinetics of displacement traces. The competition assay depicted in FIG. 8B is one involving synergistic effects, in which the presence of analyte may cause increased binding of Ca⁺² to xylenol orange, thereby giving rise to signal modulation. In both approaches, very little covalent bond architecture may be required. Only the receptors are immobilized on the beads. The indicators may change color as their extent of binding to the immobilized receptors changes. A detectable pattern may be produced in as little as seconds or in under 20 minutes.

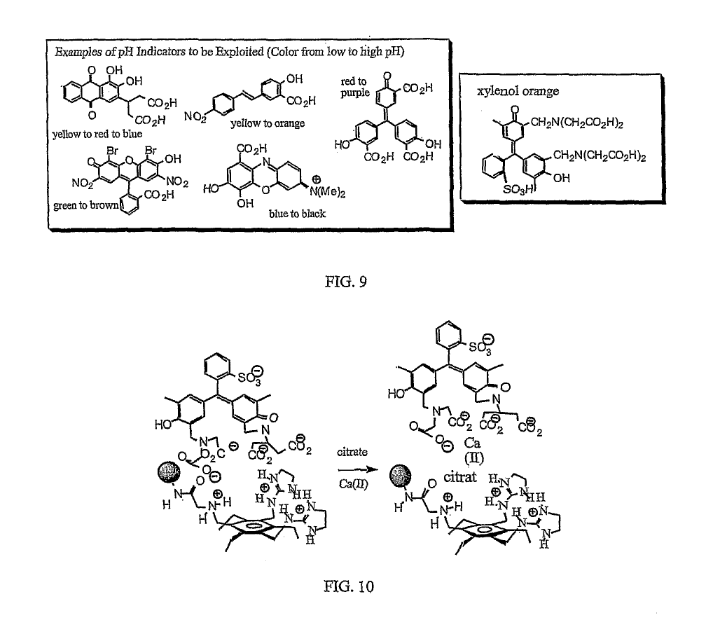

In some embodiments, the detectable pattern may include changes in emission, or absorption, or modulation of the local dielectric or ionic strength near a fluorophore or chromophore. In an embodiment, pH indicators, such as those depicted in FIG. 9, may be used. pH indicators may be used to signal the presence of analytes other than H₃O⁺. A high positive charge in a microenvironment may lead to increased deprotonation of an indicator in that environment if the conjugate base of the indicator is negatively charged. Conversely, local negative charge may decrease the deprotonation of such an indicator. Both changes result in a difference in the protonation state of pH sensitive indicators present in that microenvironment.

In some embodiments, the detectable pattern may include spectroscopy changes accompanying the chelation of metals to ligands that have chromophores. In fact, many colorimetric/fluorescent sensors for metals may rely upon such a strategy. Binding of the metal to the inner sphere of the ligand leads to ligand/metal charge transfer bands in the absorbance spectra, and changes in the HOMO-LUMO gap that lead to fluorescence modulations. If the binding of an analyte can be coupled with the binding of a metal to a chromophoric ligand, the metal may be used to trigger the response of the sensor for the analyte. For example, a sensor array may produce a detectable pattern based on colorimetric results obtainable by using Ca(II) and xylenol orange. The compound known as xylenol orange, depicted in FIG. 9, undergoes a large wavelength shift upon exposure to Ca(II). The binding of Ca(II) to xylenol orange may be altered by the addition of an analyte of interest and this may produce a detectable pattern.

In some embodiments, a fluid or gas is passed over the array slowly. One or more visualization agents are quickly added to the array. The stronger the attraction between the analyte in the fluid or gas and the particles in the array, the less one or more visualization agents interact with the particle. Displacement of the analyte from the particle may be evaluated for each particle in the array and a detectable pattern may be created. Each visualization agent may displace the analyte differently and/or each visualization agent may displace different types of analytes differently. Therefore, the pattern created by visualization agents displacing analytes from receptors may be associated with an analyte or type of analyte. The pattern may be compared to patterns obtained for known analytes or types of analytes to identify the analyte or type of analyte.

Cross-reactivity may exist between the receptors. For example, citrate, tartrate, malate, and gallate receptors may respond to citrate, tartrate, malate, and gallate, yet each may have a different selectivity among these analytes. Further, all the sugar receptors may associate to the several types of sugars; yet, there will be a differential response of each receptor for each sugar. Further, when the receptors derive from combinatorial libraries, there will inherently be a differential response from each library member, such as for the pectins and tannins. In an embodiment, quantitative-fingerprints of carboxylates and sugars in wine may be done with ANN. A user may train the program by generating a series of calibration curves using varying concentrations of all the analytes. The training set is used to create correlations and extrapolations between the training set data that then interprets the data from the unknowns.

Qualitative fingerprints may be produced using principle coordinate analysis (PCA), a technique which generates vectors in multi-dimensional space diagnostic of solution composition. The PCA method may be used as a data reduction method. Since each sensor array analysis serves to generate hundreds of inputs (i.e. red, green, blue color histograms at numerous beads) the number of points exceeds the number of observations. The PCA method may be used to overcome redundancy in the data set by transforming the data into a set of new uncorrelated variates, which are referred to as principal component (PC) loadings (factors). Upon this transformation, only the first few PC loadings are required to describe the information present in the original data. The greater span along the axes of the groups of data may give a greater reliability of differentiating between the solutions. In most cases of array sensing, the variance between the data that differentiates the solutions derives mostly from a subset of the sensors in the array. For example, each particle may contribute differently to the variance within the data. By determining which particles produce the most variance, those particles that were most important to the success of the PCA protocol may be isolated. Similarly those particles that have little variance can be isolated since they contribute little to the span along the factor axes, and therefore are not as important to the differentiation between the solutions.

The data processing for the qualitative-fingerprinting may also use discriminant analysis (DA). Discriminant analysis may be applied to the PC loadings for origin determination. Discriminant analysis is a procedure for identifying boundaries between groups of analytes. Several training sets may be used and discriminant analysis may maximize the distance between the training sets for different groups of analytes. As long as the in-group variance is less than the between-group variance, discriminant analysis can be used to correctly classify the unknown samples by assigning it to the closest training set.

In some embodiments, displacement by analytes will lead to color changes. Patterns of color changes may be obtained in two ways for ultimate use in PCA or ANN (artificial neural network analysis). The first is a “stop-flow” experiment. The array may be subjected to a flow of fluid or gas containing analyte for a short period (a few seconds), and then allowed to sit for a few minutes. Displacements of the dyes by the analytes may cause the particles to change color, although they will be free in solution within the beads. The color will need to be recorded before significant diffusion of the indicators into bulk solution occurs. The first signs of diffusion of indicators out of the beads into the surrounding solutions may take approximately 10 to 15 minutes. The second method will be a “flow” method, where kinetics is measured. This is the method may be used in the PCA analysis of phosphate derivatives. The kinetics of displacement of the indicator from the particle may be monitored, and the rate is used in PCA. The rates of displacement of the indicators is different for the various library members, creating a pattern due to differential binding of both the indicator and the analyte by the beads. This does not rely upon a color change, but such a change would supply additional information that could be incorporated into the pattern.

The term ‘protein-detecting array’ has been coined to describe an analytical device consisting of a series of protein receptors. Classically, such an array includes highly selective protein-binding agents. Unfortunately, the creation of synthetic receptors with high affinity and specificity for proteins is particularly challenging due to their molecular complexity.

An alternative to the use of highly selective receptors is to employ differential receptors. This method uses an array of receptors having good affinity, but not necessarily high selectivity, for a particular target. When functioning in tandem the combined response of the receptors creates a pattern that is diagnostic for each analyte. Because the response of the receptor array does not necessarily rely on specific recognition interactions between substrate and analyte, highly challenging analytes can be targeted.

In one embodiment, differential sensing may be achieved by creating libraries of receptors that are biased towards particular analyte classes. Using this approach, a microchip-based array incorporating a combinatorial library of receptors may be effective in differentiating nucleotide phosphates with an indicator-displacement assay. Additionally, this strategy may be used toward the development of a library of differential receptors biased towards proteins and glycoproteins. When combined with an indicator-uptake visualization assay and principal component analysis (PCA), the library gives differentiation of proteins and glycoproteins, as wells as subtle differentiation within each protein class.

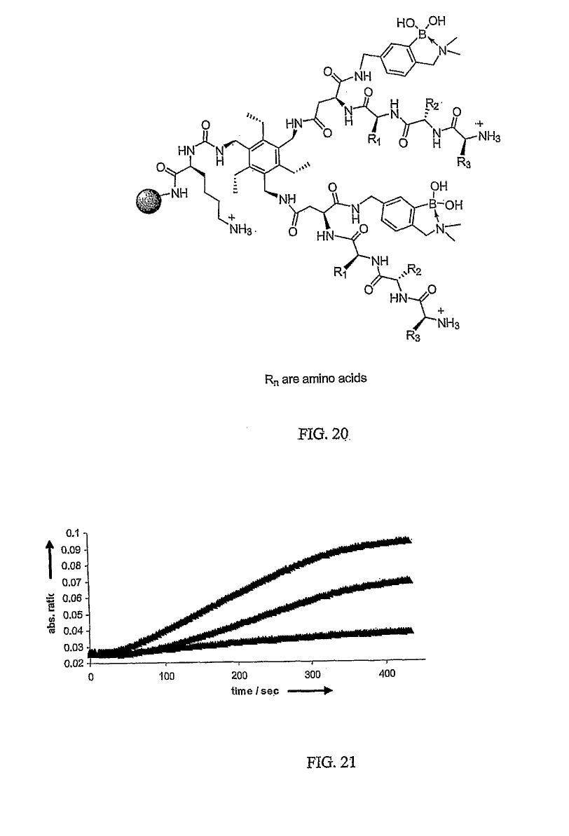

To differentiate various proteins and glycoproteins, a synthesized library was prepared having the general structure depicted in FIG. 20. The synthetic library incorporates one of 19 natural amino acids (cysteine may be excluded) at each of three sites on two different binding anus using combinatorial chemistry. While the figure depicts amino acids on three sites on two different binding arms, the receptor may include amino acids at each of from two to twenty sites on two or more different binding arms. This created a library with 193 (6,859) unique members. The peptide arms provide sites for molecular recognition of proteins via ion-pairing, hydrogen bonding, and the hydrophobic effect. The boronic acids provide effective sugar binding sites because these groups rapidly and reversibly form cyclic esters with diols in aqueous media. The hexasubstituted benzene scaffold acts as a spacer and assists in the creation of a binding cavity. Our expectation was that each receptor would show differential binding with proteins based on the variance in the peptide arms, and the boronic acids would assist in differentiation of proteins from glycoproteins.

Chemicals for the synthesis of the library depicted in FIG. 20 were purchased from Novabiochem and used without further purification. All solvents used were obtained from dry stills. The proteins used in the assay were obtained from Sigma-Aldrich and ICN and were used without further purification. Buffer components were of reagent grade. The components and fabrication of the micromachined bead array analysis system have been previously reported. Adrian Goodey, John J. Lavigne, Steve M. Savoy, Marc Rodriguez, Theodore Curey, Andrew Tsao, Glen Simmons, John Wright, Seung-Jin Yoo, Youngsoo Sohn, Eric V. Anslyn, Jason B. Shear, Dean P. Neikirk, John T. McDevitt, “Development of Multi-analyte Sensor Arrays Composed of Chemically Derivatized Polymeric Microspheres Localized in Micromachined Cavities,” J. Am. Chem. Soc., 2001, Vol. 123, 2559-2570, incorporated herein by reference in its entirety.

29 beads derivatized as depicted in FIG. 20 and six N-acylated blank beads were placed into individually addressable etched cavities within a 7×5 array on a silicon wafer microchip. The loaded array was placed into a flow cell. The flow cell was positioned on an Olympus SZX 12 stereoscope that allowed for bottom illumination of the beads in the array using a General Electric Quartzline lamp as the illumination source. Image capture was performed with a 12-bit DVC 1312C (DVC, Austin, Tex.) charge-coupled device (CCD) mounted on the stereoscope and interfaced with Image Pro Plus 4.0 software (Media Cybernetics). Introduction of indicator, analyte, buffer, and wash solutions into the flow cell was conducted using an Amersham Pharmacia Biotech AKTA Fast Protein Liquid Chromatograph (FPLC) controlled by Unicorn 3.0 Software.

Each assay was performed at room temperature under continuous flow conditions. All protein and indicator solutions were buffered with HEPES (25 mM) at pH=7.40. At a flow rate of 0.25 mL/min, 5 mL of each protein (0.355 μM) sample was loaded into the flow cell. To ensure complete removal of non-specifically bound proteins, a three minute HEPES (25.0 mM, pH=7.4) wash was employed at 1.0 mL/min. Following this rinse, bromopyrogallol red (3.0 μM) was immediately injected at 1.0 mL/min. Indicator-uptake was monitored by 2 0 capturing 12-bit images every 2 seconds for a total of 215 images. To repeat the experiment, the array was regenerated by washing for 13.5 minutes with 0.15 M NaOH at 1.5 mL/min, for 22 minutes with 0.30 M HCl at 3.0 mL/min, and finally for 4.5 minutes with 0.40 M NaOH at 1.5 mL/min. A 2 minute buffer rinse at 2.0 mL/min followed to rinse any excess base from the array.

Array images were analyzed by drawing an area of interest (AOI) around each bead and evaluating the average red, green, and blue pixel densities within this AOI. For simplification, only the green channel intensity values were utilized for further analysis. The green channel intensity, I_{G}, was converted to an effective green absorbance, A_{G}, using Beer's Law (A_{G}=−Log (I_{G}/I_{B})), where I_{B} was the average green pixel intensity of a blank N-acylated bead. The N-acylated blank beads remained colorless throughout the assay indicating little to no dye uptake.

Novasyn TG amino resin purchased from Novabiochem with a loading value of 0.26 mmol/g were used for the library synthesis. Synthesis was completed via the route shown in Scheme 1. All common amino acids were used except cysteine; however, cysteine may be employed. Each was Fmoc protected and side chains were appropriately protected with t-butyl, Pbf, trityl, or Boc.

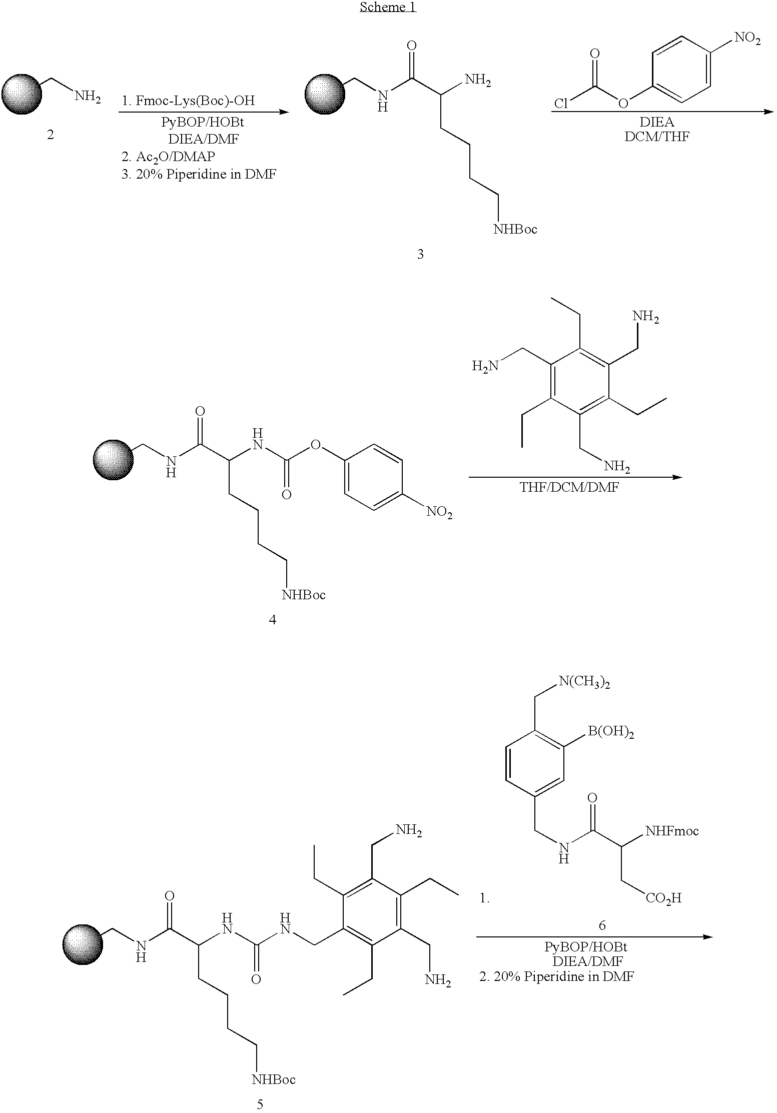

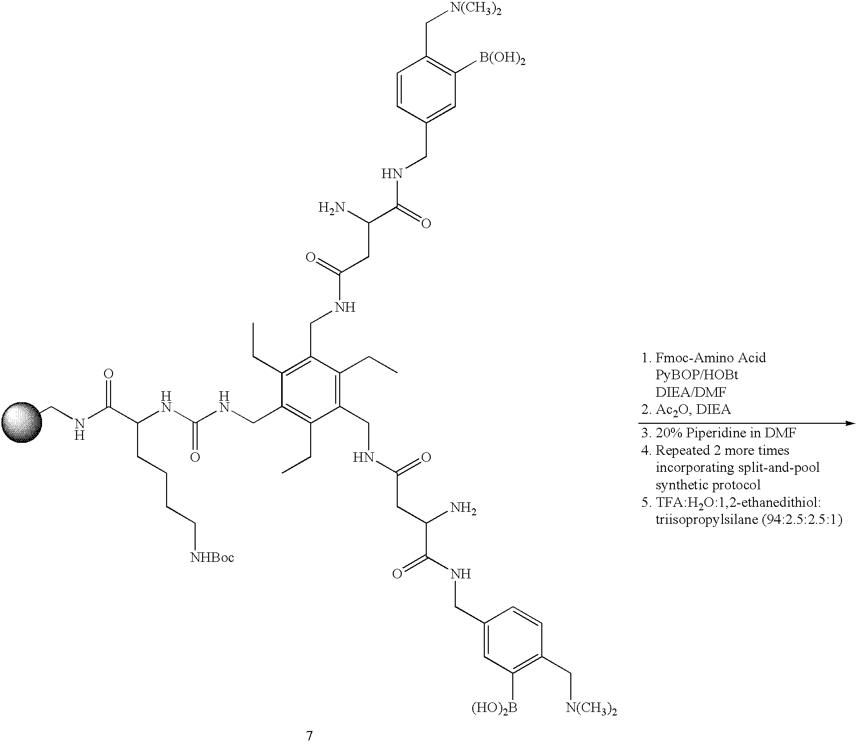

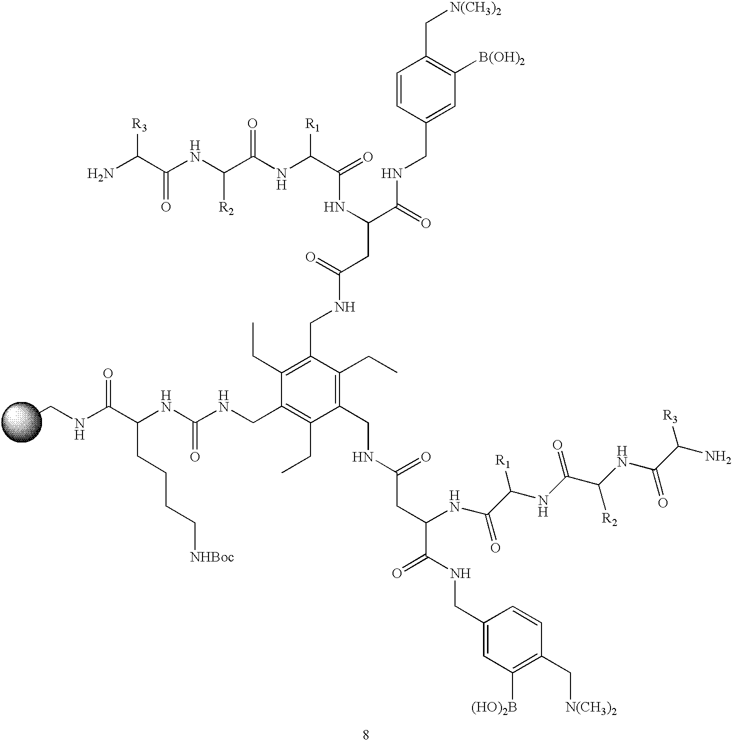

Novasyn TG amino resin 2 (1.2 g, 0.31 Mmol) was added to a solid-phase reaction vessel (50 mL reaction vessel with a frit for evacuating reaction solutions and wash solutions) and allowed to swell for 30 min. A solution of Fmoc-Lys(Boc)-OH (0.292 g, 0.62 mmol), 1-hydroxybenzotriazole (HOBt) (0.084 g, 0.62 mmol), benzotriazole-1-yl-oxy-tris-pyrrolidino-phosphonium hexafluorophosphate (PyBOP) (0.322 g, 0.62 mmol), and diisopropylethylamine (DIEA) (0.216 mL, 1.24 mmol) was prepared in DMF (5 mL). This was mixed at room temperature for 4 h. The reaction solution was evacuated and the resin was rinsed with DMF, methanol, methylene chloride (DCM), and hexanes. DMF (5 mL) was added to the resin along with acetic anhydride (0.1 g, 1 mmol) and dimethylaminopyridine (DMAP) (1 mg). This mixed for 30 minutes to cap all unreacted amines. Again the resin was washed as before, and then 20% piperidine in DMF (5 mL) was added to deprotect the Fmoc protecting groups. This mixed for 5 min. Again 20% piperidine in DMF (10 mL) was added and mixed for 5 min. The resin was washed twice with DMF, DCM, methanol, and hexanes. The resin was then dried on the hi-vac.

3 was initially swelled in THF/DCM (1:1, 5 mL) for 30 min. A solution of 4-nitrophenylclioroformate (0.312 g, 1.55 mmol) in THF/DCM (1:1, 5 mL) and DIEA (0.27 mL, 1.55 mmol) was added to the resin. This mixed for one hour and the solution was evacuated. The resin was rinsed several times with 1:1 THF/DCM, and then dried on the hi-vac.

4 was added to a solution of 1,3,5-tris-aminomethyl-2,4,6-triethyl benzene (0.62 g, 2.5 nunol) in THF/DCM (6 mL, 1: 1) and DMF (4 mL). This mixed overnight and was evacuated. The resin was then washed with DMF followed by 5% butylamine in DMF until the solution remained colorless. The resin was then washed twice with methanol, DCM, and hexanes. The resin was dried on the hi-vac.

5 was swollen in dry DMF (5 mL) for 30 min. A solution of 6 (1.45 g, 2.2 mmol), PyBOP (1.14 g, 2.2 mmol), HOBt (0.30 g, 2.2 mmol), and DIEA (0.76 mL, 4.4 mmol) was prepared at 0° C. in DMF (5 mL) as the solution tends to warm upon addition of DIEA. After the solution cooled to room temperature it was added to the swollen resin. It was spun for 4 h. and then the solution was evacuated. A Kaiser test was performed and was negative. The resin was washed with methanol, DCM, DMF, and hexanes. The Fmoc groups were removed with 20% piperidine in DMF (10 mL). The resin was washed twice with methanol, DCM, DMF, and hexanes. A Kaiser test was performed and was positive. The resin was dried on the hi-vac.

The library was synthesized using standard split-and-pool combinatorial chemistry. Resin 7 was split into 19 equal portions. One of the 19 amino acids (0.47 M), HOBt (0.47 M), DIEA (0.47 M), and PyBOP (0.47 M) solutions were added to each of the resin portions and mixed overnight in DMF. The reaction solution was evacuated and the resin washed with methanol, DCM, DMF, and hexanes. DMF (5 mL) was then added to the resin along with acetic anhydride (0.1 g, 1 mmol) and DIEA (0.47 M). Following evacuation and rinses, 20% piperidine in DMF (5 mL) was added and mixed for 10 minutes. This was evacuated and the resin was rinsed with methanol, DCM, DMF, and hexanes. All 19 portions of the resin were mixed together once again and then split again into 19 equal portions. The synthetic split-and-pool procedure was performed until three amino acids were added to both arms of the receptor. The acid-labile protecting groups on the amino acid side chains were removed using a TFA/water/1,2-ethanediol/triisopropylsilane (94:2.5:2.5:1, 12 mL) solution. The resin was washed twice with DCM, methanol, and hexanes, thoroughly dried on the hi-vac, and subsequently used in the array.

The 7×5 array including 29 randomly selected resin beads from the created library depicted in FIG. 20 was used along with six acylated resin blanks to detect different types or proteins. Each bead was placed in a micromachined chip-based array platform. The patterns created by the array of receptors are obtained by measuring the red, green, and blue transmitted light intensity for each bead using a charge-coupled device attached to a customized reader.

In order to create diagnostic patterns for each protein, a signaling protocol was incorporated. Previous work utilized indicator-displacement assays; however, at the low protein concentrations used in this study it was more advantageous to evaluate the rate of indicator-uptake. Our indicator-uptake signaling protocol allowed us to use protein concentrations of less than 1 mM. We incorporated the commercially available indicator, bromopyrogallol red, for the indicator-uptake calorimetric analysis. This indicator forms reversible cyclic esters with the boronic acids of the receptor.

Our experimental protocol starts with a delivery of 5 mL of a protein solution (355 μM in HEPES buffer) using a 0.25 mL/min flow rate. This is followed by a three minute buffer (25 mM HEPES, pH=7.4, 1.0 mL/min) wash, and then delivery of bromopyrogallol red (3.0 μM in HEPES buffer, 1.0 mL/min). After each analysis, the protein and indicator are washed from the array with NaOH (150 mM) and HCl (300 mM) rinses. This allowed for repeated use of the array. A 12-bit image is captured every two seconds during indicator uptake, from which a slope is garnered from a graph of time versus green channel absorbance for each receptor bead in the array. Effective absorbance values were obtained by calculating the negative log of the ratio of the green channel intensity of each bead to the green channel intensity of a blank bead.

Ovalbumin, fetuin, lysozyme, bovine serumn albumin (BSA), and elastin were used for this study. These choices were made to challenge our design principles by grouping proteins of similar properties. The characteristics of the proteins span a variety of molecular weights, glycosidic properties, and isoelectric points (pI). The molecular weights of ovalbumin and fetuin are similar, as are elastin and BSA. The pI of ovalbumin, BSA, and fetuin are similar, as are lysozyme and elastin (See Table 1).

TABLE 1

| | M.W. | | |
|---|---|---|---|
| protein | (kDa) | pI | Glycoprotein? |
| Ovalbumin | 44-45 | 4.6 | Yes |
| Fetuin | 48.4 | 4.5-4.9 | Yes |
| Lysozyme | 14 | 9.6-11 | No |
| BSA | 66 | 4.7-5.2 | No |
| Elastin | 60 | 9.3-10.2 | No |

Four trials were performed for each protein. The indicator-uptake slopes were calculated for each receptor bead over the time period at which the dye was passing through the array (49 to 403 s). An illustration of the differences in indicator uptake from different resin-bound receptors can be seen in FIG. 21. For each trial a slope is measured for each bead (blanks not included). Because of the large number of slopes calculated from each trial, the dimensionality of the data set was simplified using PCA.

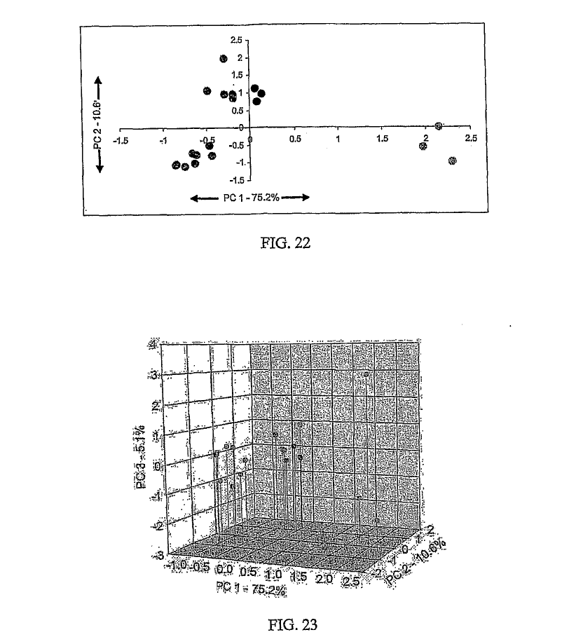

In PCA, the first principal component (PC) axis is calculated to lay along the line of maximum variance in the original data set. Subsequent orthogonal axes are calculated to lie along lines of diminishing levels of variance. In this study, the first four PC axes effectively satisfied the Kaiser criterion, which states that as many factors could be extracted as variables that have eigenvalues greater than one. FIG. 22 shows a two dimensional PCA plot which effectively separates the different protein classes. As illustrated there is a detectable differentiation between proteins and glycoproteins. Because four PC axes are outside the range of error it was possible to generate a three-dimensional PCA plot that further separates the proteins. FIG. 23 shows an expanded PCA plot using PC axes 1-3. This demonstrates that the array to receptors adequately separated proteins from glycoproteins, and to a lesser extent even separates proteins within the classes. The fact that a random selection of receptors was used to achieve these results illustrates the utility of this procedure. More than likely any one of these 29 receptors would not have been a good receptor for a particular protein, however, when functioning in tandem, the array works well. Further, any 29 receptors could presumably be used to obtain analogous patterns for the proteins. PC axis 4 (4.7%) could have also been used for further discrimination in another plot.

A control was performed using a 7×5 array with six blanks and 29 resin beads derivatized only with tripeptides that were obtained from a combinatorial library synthesized with 19 natural amino acids (cysteine excluded). Using this array of tripeptide beads, no separation of analytes occurred. This control illustrates that some design should be incorporated into the receptors to bind certain analyte classes, and that simple random receptors are inefficient. These results do not strictly demonstratehat the boronic acids bind to glycoproteins and not standard proteins. More likely the boronic acids interact with surface epitopes on both protein classes, but to different extents. Yet, if differential covalent bond formation to the boronic acids was the only factor in discrimination between protein classes, then because they are the only binding moiety present in every receptor we would expect no differences within each protein class. Therefore, both the boronic acids and the variable peptide arms of the receptors are critical in identification and discrimination of proteins and glycoproteins.

Reduction to practical concentrations (nM) may be accomplished with higher affinity differential receptors. Additionally an analysis cell that recycles the analyte solution through the array leads to extremely sensitive assays.

The PCA plot demonstrates similarities between ovalbumin and fetuin, and similarities between elastin and lysozyme. Yet, even the proteins in similar groups are separated. The proximity of ovalbumin and fetuin is reasonable as both are glycoproteins with similar pI values, and both likely interacted with the boronic acid moieties. Further, elastin and lysozyme have similar pl values. Therefore, the separation in our analysis is not simply a facet of charge. Initerestingly, molecular weight also did not play a large role in the patterns exhibited. BSA is likely separated from the others because it has a different pI than elastin and lysozyme and is not a glycoprotein. The differentiation between similar proteins is likely due to specific contacts between the receptors and proteins that are cross-reactive and subtly discriminatory.

Factor loading values are calculated in PCA to determine the magnitude of contribution of an original variable to the formation of a PC axis. Variables with loading values approaching −1 or 1 have a dominant role in the formation of a PC axis. Because PC axis 1 described the most variance, five beads with high loading values on PC 1 and two beads with low loading values were selected for receptor characterization (Table 2) using Edman degradation. The sequencing results do not show any obvious homologies. Yet, the lack of any homology is a lesson in itself: differential sensing schemes can be successful and may even benefit from a wide variety of structurally diverse receptors.

TABLE 2

| | Factor | |
|---|---|---|
| Tripeptide | loadings | Bead |
| sequence | (PC1) | number |
| Ala-Ser-Asp | 0.984 | 12 |
| Ser-Lys-Gly | 0.963 | 9 |
| Arg-Lys-Lys | 0.951 | 15 |
| Gly-Asp-Ser | 0.932 | 2 |
| Asp-Leu-Val | 0.928 | 22 |
| Lys-Arg-Met | 0.774 | 23 |
| Gly-Gln-Gln | 0.722 | 6 |

In summary, we have shown that the use of an array of differential receptors can differentiate between classes of proteins, and even between very structurally similar proteins. This separation was not due to charge differences nor molecular weight differences, but rather specific contacts between receptors and proteins giving discriminatory patterns. This methodology may also be used for the qualitative analysis of complex mixtures of proteins.

In an embodiment, it may be advantageous to simultaneously analyze each receptor with a series of pH indicators. In other words, because each bead-based receptor may interact with indicators differently, the use of several indicators with the same receptor may easily increase the diversity of the receptor/analyte differential responses, and hence add to the fingerprint. For example, the use of two indicators along with two receptors increased the range of spectral responses and may allow differentiation between tartrate and malate.

As depicted in FIG. 5, arrays may include isolated quadrants which can receive separate fluid or gas flows. In an embodiment, an array may include six particles including receptors, such as those shown in FIG. 3A-F, in each quadrant, and four indicators: alizarin complexone, pyrocatechol violet, bromo pyrocatechol violet, and texas red, loaded into the individual quadrants. Each quadrants may receive aliquots of the same solution as the matrix to generate the training set for a ANN. The ANN may then be used to examine unknown solutions.

In some embodiments, Ca(II) levels may be monitored. Non-covalent binding of xylenol orange to a resin-bound guanidinium/boronic acid based receptors may be due to intramolecular interactions between the carboxylates of the indicator and the guanidiniums/boronic acids of the receptor. The coordination of the carboxylates of xylenol orange may result in a decreased affinity for Ca(II). However, there may be cooperative binding of Ca(II) and our analytes. Once one of the carboxylate or sugar analytes is bound to its respective receptor, it may competitively displace the carboxylates of xylenol orange leading to increased Ca(II) binding, see FIG. 10. This in turn will result in a color modulation. Similarly, binding of Ca(II) to xylenol orange leaves the guanidiniums/boronic acids free to bind analytes. This may be a synergistic effect since it does not rely on a protonation state change, but instead cooperative effects in binding Ca(II) and analyte. The assays may be most sensitive at concentrations of the analytes and Ca(II) near their dissociation constants, where neither receptor or indicator is saturated, and small changes in the extent of binding lead to large changes in absorbance. The addition of citrate to a mixture of xylenol orange and as depicted in FIG. 10 in a 1:1 methanol:water mixture may give a response that is dependent upon the concentration of Ca(II). Reproducibly different UV/vis tirations are found upon adding citrate to a mixture of 1, xylenol orange, and Ca(II) at different levels. The addition of citrate may facilitate identification of other carboxylates as sugars as well as tannins/pectins using similar receptors.

In some embodiments, the sensor array may be used to analyze different analytes using ensembles of synthetic receptors and common indicator molecules. A solution containing an analyte may be added to particles in a sensor array and the absorbance changes may be assessed using a proximally located CCD that is optically coupled to the particles. For example, red, green, blue absorbance values may be measured. Analyte concentrations may be extracted form the data obtained from the sensor array in a reproducible manner. In an embodiment, carboxylic and phosphoric acids and sugars may be added to the array to determine the effect the variations in other analytes have on measured concentrations.

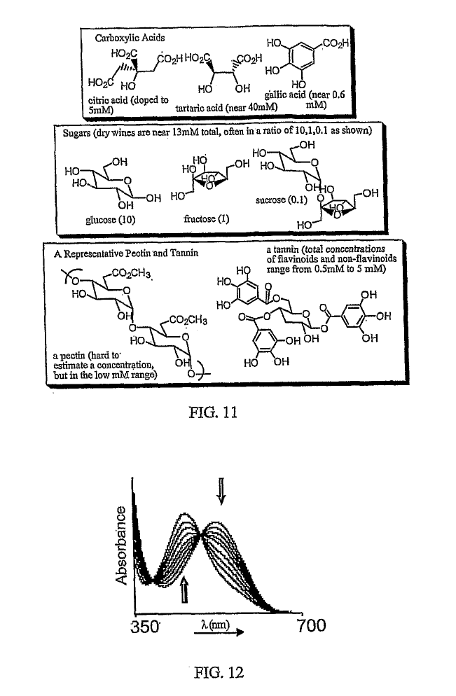

The analysis of wine using a sensor array may be desirable because of biomedical relevance or for quality control and/or identification of wines. Wine is more complex than most common beverages, such as sodas and power drinks; and hence, success with wine will bode well for a general method that can be used by the entire beverage manufacturing industry for quality control and flavor analysis. Many of the components of wine are very structurally similar, and hence may be difficult to analyze using methods currently known in the art. Further, the average wine has approximately 200 different components. Many of the components can be segregated into the four basic groups: carboxylic acids, sugars, pectins, and tannins (FIG. 11) or two classes. Class I are those structures that are known: the carboxylates and sugars. Class II are those structures which have not been completely characterized and vary from one varietal to another: pectins (oligosaccharides) and tannins (flavinoids). Class II structures are difficult to analyze using highly selective beads since the structures are not completely known, differential receptors facilitate analysis of these structures. The pattern created by all the receptors acting together may be used to classify the varietal of a wine, its age, and maybe even its origin.

In an embodiment, only three receptors, such as receptors similar to those depicted in FIG. 3A-C, may be necessary for the quantitative-fingerprinting of the carboxylates (dominant and non-dominant) in wine. There are only three dominant carboxylates in wine: tartrate, malate, citrate (not naturally occurring but is added). Further, tannic acids may have functionality similar to these abundant carboxylates. Even though there may be cross reactivity, the combination of tartrate and malate can be quantitated with a receptor similar to the receptor depicted in FIG. 3B and tartrate and malate can be simultaneously quantitated using a combination of receptors such as those depicted in FIG. 3B-C. Therefore, in the context of wine, tartrate and malate may be so predominant that they constitute the majority of the response of our receptors. These may also be the major carboxylates that vary depending upon the varietal, the age of the wine, and the time the grape has matured on the vine.

Receptors with bis-boronic acid attractive components, similar to those depicted in FIG. 3D-F, may be used to detect sugars. The binding of phenols to the boronic acids to make boronate esters may change the indicator protonation state. This may modulate the spectroscopy of the pH sensitive indicators that associate with the beads. In an embodiment only three different sugar receptors may be used, even though there are four major sugars in wine: fructose, sucrose, glucose, and to a lesser extent cellubiose. However, four, five, six or more receptors may be used to identity sugars. These receptors may be designed to place the boronic acids in different arrangements (many diamines are commercially available, and these receptors are single step syntheses from the corresponding diamines).

The binding constants for sugars with bis-boronic acids may be in the range of 103-104 M−1 in pure water. Due to the lower dielectric environment presented by the beads, some enhancement in the binding may be expected. However, even if the receptors belhave as they do in pure water, their affinities may be high enough to give the appropriate sensitivity needed in our assays.

Although specific embodiments and uses of the sensor array have been described, the sensor array may be used to analyze any complex solution, including, other beverages, foods, blood, urine, saliva, and enviromnental samples.

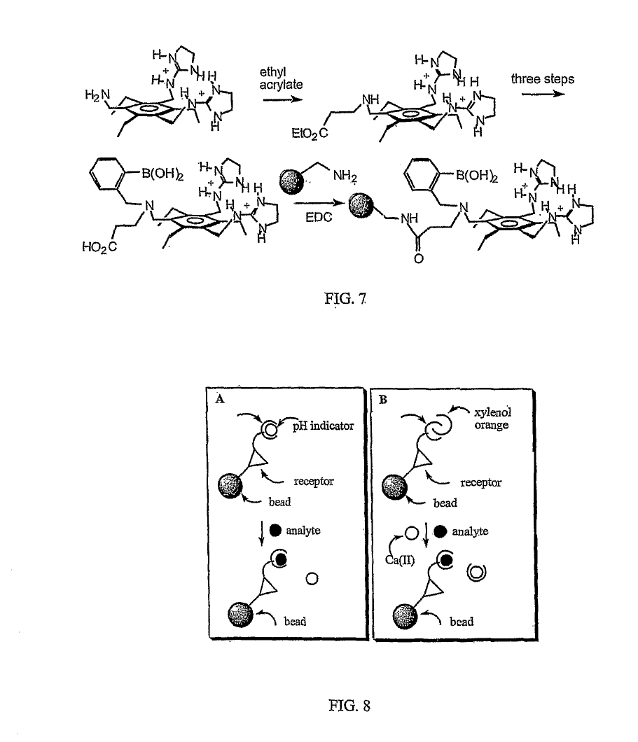

FIG. 7 depicts an embodiment of a method of coupling a receptor to a bead. Synthesis of the amino-guanidine triethylbenzene starting material is described in U.S. Pat. No. 6,048,732, which is incorporated herein by reference. The derivatization of the particles with receptors relied upon coupling carboxylic acids and amines using EDC and HOBT. The efficiency of couplings were greater than 90% using quantitative nihydrin tests. To attach the receptors, conjugate addition of one of the amines on the 1,3,5-triaminomethyl-2,4,6-triethyl benzene spacers with ethylacrylate is another alternative.

When loaded with alizarin complexone, the particles responded in an identical fashion as they did in solution. The relative selectivities were the same as the receptors in solution, and the color modulation of the indicator was the same.

The free energy of binding (DGo) for several carboxylate containing natural products and tannins was obtained. Tartrate and malate were simultaneously quantitated. Therefore, the differences in the free energy of binding these two analytes can be calculated. We found that a DDGo for binding tartrate and malate with the receptor depicted in FIG. 3B as 0.9 kcal/mol, while the DDGo value for the receptor depicited in FIG. 3C with these two guests is 1.4 kcal/mol. This then leads to a DDDGo value, which represents the free energy difference between the responses of the receptors to tartrate and malate (1.4-0.9 kcal/mol=0.5 kcal/mol). The two receptors, which only differ in 0.5 kcal/mol in their differentiation between two analytes, were used to quantitatively-fingerprint solutions containing these two analytes.

A citrate detecting sensor array was created using particles that included the receptors depicted in FIG. 3A. The receptor is selective for the recognition of citrate in water over dicarboxylates, monocarboxylates, phosphates, sugars, and simple salts. Our assay for citrate employed an ensemble of 5-carboxyfluorescein (CF) and 1. In a solution of 25% water/75% methanol by volume the binding constants of 1 with CF (Ka=4.7×103 M−1) and 1 with citrate (2.9×105 M−1) were determined. The binding between 1 and CF results in a lowering of the phenol pKa of CF due to the positive microenvironment presented by 1. This causes CF to be in a higher state of protonation in solution relative to when bound.

The intensity of absorption or fluorescence by CF increases with addition of 1, and decreases upon addition of citrate. Calibration curves were generated by adding stock solutions of citrate to an ensemble of 1 and CF. Finding the concentration of citrate in a large number of beverages was simply a matter of adding between 2 and 50 mL of the beverage to the ensemble following by reading the concentration off of the calibration curve.

A tartrate detecting sensor array was created using particles that included the receptor depicted in FIG. 3B. The receptor binds tartrate in water (pH 7.4) with a binding constant of 105 M−1. The receptor possesses high selectivity for tartrate over lactate, succinate, sugars, and ascorbate; only malate is competitive. This may reflect good cooperativity between the host's boronic acid moiety and the two guanidinium groups for the recognition of the guest's vicinal diol and two carboxylates respectively.

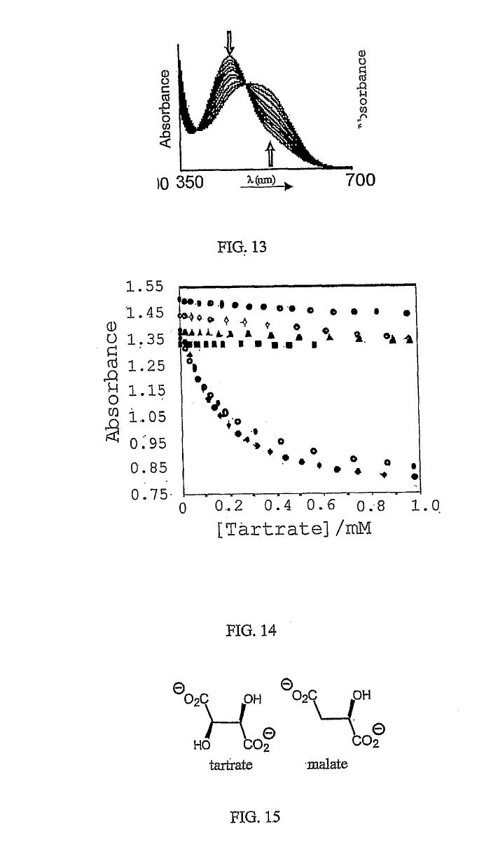

To convert the receptor depicted in FIG. 3B into a sensor for tartrate, alizarin complexone was allowed to bind to the receptor. This indicator is commonly used to sense pH, Ce(III), and F-. In combination with the receptor, it creates to a sensor for tartrate. When bound to the receptor, alizarin is yellow, but when released into solution via displacement by tartrate and malate, it turns red. FIG. 12 depicts the result of adding alizarin. FIG. 13 depicts the addition of tartrate to the sensor array leading to a color change. Calibration curves derived using standardized tartrate solutions gives an assay that accurately quantitates tartrate in red and white wines, as well as other grape derived beverages. FIG. 14 depicts calibration curves showing the selectivity of the receptors for tartrate/malate, from to top to bottom the curves are for ascorbate, lactate, succinate, glucose, malate, and tartrate.

A gallate detecting sensor array was created using particles that included the receptor depicted in FIG. 3C. The receptor bound to gallate. We quantitated a class of structurally related tannic acids. Gallate was the primary target, but we showed that this receptor had differential binding properties with five other tannic acids. The composite response of all the tannic acids allowed us to correlate the aging of scotch whisky to the general tannic acid levels. The kind of receptor used had a broad but differential response to a series of structurally related analytes.

A sensor array was created for the multicomponent analysis of carboxylates. hi an extension of our tartrate and gallate sensing ensembles (described above), we created a four component sensing ensemble that simultaneously quantitates two very structurally similar analytes: tartrate and malate, see FIG. 15. These analytes differ only in the presence or absence of one hydroxy respectively. The receptors depicted in FIG. 3B-C were added to a solution of the indicators pyrocatechol violet and bromo pyrocatechol violet, thereby making a solution with four components. UV/vis spectra were measured with varying ratios of tartrate and malate, changing the concentrations by 0.05 mM increments. The indicators bound the two receptors differently, and the indicators were displaced by tartrate and malate differently.

Isosbestic points in the spectra were found, and spectral differences for each mixture of tartrate and malate were obtained. For each spectra obtained, the absorbance values at 27 different wavelengths were used as a training set in an artificial neural network analysis. The sensor array was then challenged with unknown mixtures of tartrate and malate, and in each case produced a concentration of each analyte that was at most only 5% different than the actual concentration, and 2% error was the standard result. The technique of using differential receptors with pattern recognition allowed measurement of the concentrations of each simultaneously.

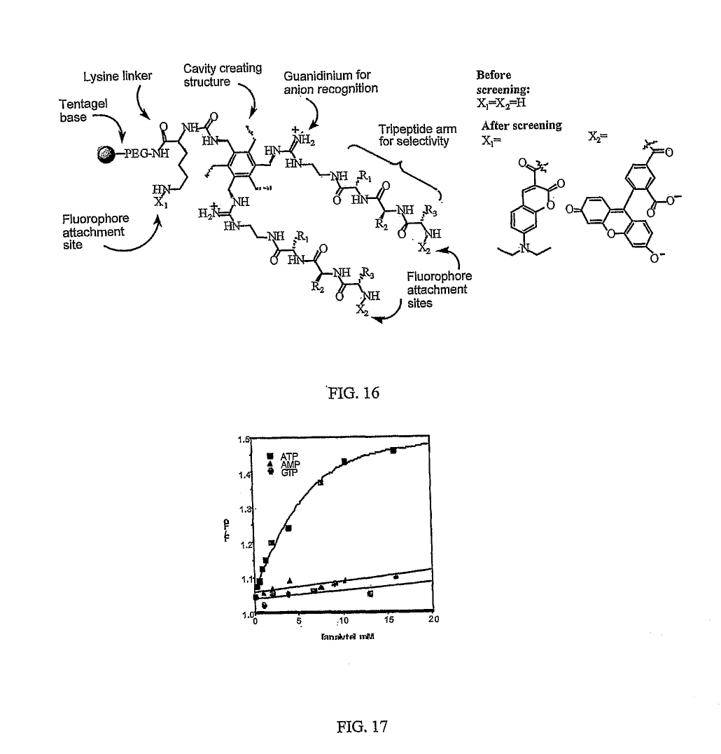

A selective ATP receptor was created, an embodiment of which is depicted in FIG. 16. Tripeptide arms, derived from combinatorial chemistry, were chosen to impart selectivity based upon interactions with the adenine group of ATP. Thus, the receptor was designed with 5-carboxyfluorescein appended to the ends of the peptide chains, while 7-diethylaminocoumarin-3-carboxylic acid was attached to the lysine to act either as an internal reference or to give a fluorescence resonance energy transfer signal transduction mechanism. Further, guanidinium groups were incorporated to ensure some binding to the ATP.

A series of fluorescence studies were performed using a thin layer of beads sandwiched between two layers of gold mesh on a glass slide. The beads equilibrated rapidly upon addition of analyte (2-3 min was allowed) and the background variance was limited to approximately 2%. A large spectral response upon addition of ATP was observed with the Ser-Tyr-Ser receptor, see FIG. 17. Since the Ser-Tyr-Ser receptor gave the largest fluorescence change upon addition of ATP, it was chosen for further studies with AMP and GTP. This receptor exhibited very high detection selectivity for ATP over these structurally similar potentially competing analytes. The attachment of fluorphores to a base structure of a receptor creates resin bound chemosensors with good selectivity and sensitivity.

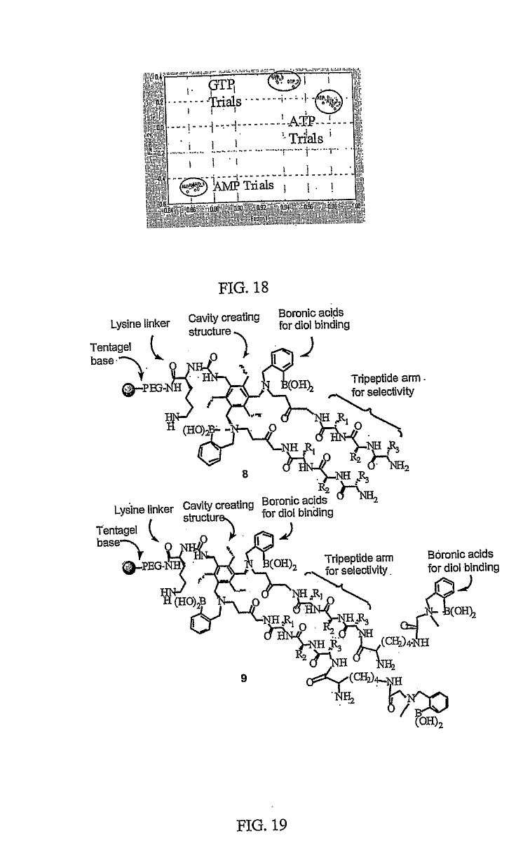

Using this receptor, a random selection of 30 beads and 5 blank beads were loaded into a 5 by 7 array. Prior to the analysis the beads were charged with an indicator, fluorescein. Under the conditions of the analysis, the anionic dye was found to bind to the cationic receptor cavity. Upon exposure of the solutions containing various phosphate species, the dye molecules were displaced at various rates depending on the local chemistry therein. The magnitude of the dye displacement, as measured by our array platform, was then quantitated for each of the beads as various samples were introduced. After completion of multiple identical trials for these phosphate derivatives, the data was treated with principle coordinate analysis as shown in FIG. 18. As depicted in FIG. 18, the analysis of the receptor used shows good discrimination between AMP, GTP, and ATP.

The randomly chosen pool of beads led to patterns for ATP that were different than for GTP. In other words, using principle coordinate analysis (PCA), solutions containing ATP can be distinguish from those containing the very structurally similar analyte GTP.

Six beads of the random set of 35 beads were most significant in producing the variance found in factor 1 and factor 2 of the PCA analysis. We sequenced these beads and found a remarkable consistency. Of the six beads sequenced, there was a predominance of Ser or Thr in either position one or three of the tripeptide, and an aromatic amino acid in position two.

Pectins and tannins may be detected using receptors similar to those shown in FIG. 19. A hexasubstituted benzene base was used to generate cavities, along with extensive incorporation of boronic acids to bind the diols and catechols of the pectins and tannins, and oligomeric peptides to introduce diversity. A cavity is ensured, and the boronic acids direct binding to the pectins and tannins; it is left to peptides to direct selectivities.

With respect to pectin binding, receptors including aspartic acid, glutamic acid, asparagine, glutamine, and arginine may be used. These amino acids make ditopic hydrogen bonds to vicinal diols. With respect to tannin binding, receptors may include tryptophan, phenylalanine, and tyrosine, and the alkyl amino acids such as leucine and isoleucine. These may lead to increased hydrophobic cavities, as may be expected to enhance the binding of polyaromatic catechol structures.

Certain U.S. patents, U.S. patent applications, and other materials (e.g., articles) have been incorporated by reference. The text of such U.S. patents, U.S. patent applications, and other materials is, however, only incorporated by reference to the extent that no conflict exists between such text and the other statements and drawings set forth herein. In the event of such conflict, then any such conflicting text in such incorporated by reference U.S. patents, U.S. patent applications, and other materials is specifically not incorporated by reference in this patent.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

1.-7. (canceled)

8. A sensor array comprising:
one or more particles positioned in one or more cavities, wherein a particle comprises:
a polymeric resin bead; and
one or more receptors comprising one or more attracting components coupled to the polymeric resin.

9. The sensor array of claim 8, further comprising one or more light sources.

10. The sensor array of claim 8, further comprising one or more detectors optically coupled to one or more of the particles.

11. The sensor array of claim 8, wherein two or more of the attracting components are coupled to the polymeric resin by an additional attracting component.

12. The sensor array of claim 8, wherein at least one attracting component comprises a boronic acid.

13. The sensor array of claim 8, wherein at least one attracting component comprises a boronic acid on an end of the attracting component.

14. The sensor array of claim 8, wherein two or more of the attracting components comprise boronic acid positioned on an end of an attracting component.

15. The sensor array of claim 8, wherein at least one receptor is a synthetic receptor.

16. A method comprising:
passing a fluid over one or more particles comprising one or more receptors comprising two or more attracting components coupled to a polymeric resin bead;
detecting one or more signals produced by the interaction of one or more analytes in the fluid with one or more of the particles; and
assessing the pattern of one or more of the produced signals.

17. The method of claim 16, further comprising adding a visualization agent to one or more of the particles.

18. The method of claim 16, further comprising comparing the pattern of one or more of the produced signals to one or more known patterns correlating to one or more known analytes.

19. A method comprising:
passing a fluid comprising one or more analytes over one or more particles in a cavity of a sensor array, wherein a particle comprises one or more receptors comprising two or more attracting components coupled to a polymeric resin, wherein one or more of the analytes associates with two or more of the attracting components;
adding one or more visualization agents to the particles, wherein one or more of the visualization agents displace at least one analyte from the particle; and
detecting one or more signals produced by the displacement of at least one analyte from the at least one particle.

20. The method of claim 19, further comprising assessing the pattern of one or more of the produced signals.

21. The method of claim 20, further comprising assessing an identity of an analyte based on the pattern.

22. A method comprising:
passing one or more visualization agents over one or more particles in one or more cavities in a sensor array, wherein one or more of the particles comprise one or more receptors comprising two or more attracting components coupled to a polymeric resin, and wherein two or more of the attracting components associate with one or more visualization agents;
passing a fluid containing at least one analyte over the particles, wherein the particles interact with the analyte, and wherein at least one analyte displaces at least one visualization agent from the particle; and
detecting one or more signals produced by the displacement of one or more of the visualization agents from one or more of the particles.

23. The method of claim 22, further comprising assessing the pattern of one or more of the produced signals.

24. The method of claim 23, further comprising assessing the identity of an analyte based on the pattern.

25. The method of claim 22, wherein at least one visualization agent is xylenol orange or pH indicator.

26. (canceled)

27. The method of claim 22, further comprising adding Ca(II) to the particles.

28. The method of claim 22, further comprising washing particles in the sensor array after a signal is detected with a visualization agent.

29. The method of claim 22, further comprising washing particles in the sensor array after a signal is detected with an acid or a buffer.

30. (canceled)

31. The method of claim 22, further comprising washing particles in the sensor array after a signal is detected with an anionic or cationic indicator.

32. (canceled)
